(19) United States
(12) Patent Application Publication
(10) Pub. No.: US 2012/0055349 A1
(43) Pub. Date: Mar. 8, 2012

(54) DEVICE FOR KEEPING FOOD WARM, PORTIONING AND DISPENSING IT

(76) Inventor: Walter Degelsegger, Desselbrunn (AT)

(21) Appl. No.: 13/321,559

(22) PCT Filed: Jun. 7, 2010
(86) PCT No.: PCT/AT2010/000197

§ 371 Date: Nov. 22, 2011

(30) Foreign Application Priority Data
Jun. 12, 2009 (AT) A 903/2009

(51) Int. Cl. A47J 36/24

(52) U.S. Cl. 99/483

(57) ABSTRACT

The invention concerns a device for providing hot or warm food portions from a larger piece of food that is kept hot or warm. The device automatically portions, cuts and dispenses food portions, without the device operator having to touch the food.

Rolls with hot meatloaf are sold in many department stores, snack bars, convenience stores, etc. A large piece of meatloaf in the shape of a pie (rectangular, almost prismatic) is kept in a hot oven for this purpose. When needed, the piece is taken out, one or two sections are cut off and the piece is put back into the oven, while the pieces that have been cut off are placed between the two layers of a roll that has been cut in half and served to the customer on a plate. All this creates a lot of work, especially if the person working must also do other work and has to put on and afterwards take off gloves to handle food.

AT199403 B shows a machine that moves sausages into a rotisserie, and then dispenses them. No cutting device is provided.

AT336425 B shows a mechanical cutting knife, which is kept at sterilization temperature for hygiene reasons.

DE1532002 A1 shows an oven for meatloaf. No cutting device is provided.

DE3714199 C2, DE10136809 A1, DE102006014587 A1 and EP332895 A2 show cutting machines for food with which the geometry of the cut surface is optically measured and, using the specific weight information, the cut thickness is adjusted automatically to reach a specific off-cut weight. The main distinguishing features between the individual suggestions concern the way in which the material is brought up to the knife (slider, conveyor belt, gravity), details of the optical measurement method and the cutting plane inclination. However, keeping the food warm before cutting is not the intention here.

EP767724 B1 and EP216754 B1 show cutting devices for food, such as sausage, on which a weighing device is placed under the plate onto which the cut material falls and on which the amount to be cut is adjustable. Keeping the food warm before cutting is not the intention in this case either. Since only material that has already been cut is weighed, it must be cut into thin slices.

The inventor set the task of providing a device that can efficiently dispense hot food portions that originate from a larger piece of food, which is being kept hot.

To solve the problem, the invention offers a device that has the following features:
The device comprises a heatable chamber that can be closed, in which the food piece is arranged and kept hot.
The device is equipped with a cutting device containing a mechanical drive, which is capable of cutting off a portion from the food piece.
The device is equipped with a moving device containing a mechanical drive, which is capable of pushing the cutting device and the food piece towards each other so that the size of the piece to be cut off can be adjusted.
The device is equipped with a dispensing device through which the portion that has been cut off from the food piece is dispensed from the heatable chamber. Afterwards the chamber is closed again.
The device is equipped with a controller into which the size or weight of the piece to be cut off and dispensed can be entered, which is also capable of controlling the moving device and the cutting device.

Sketches explain the invention in greater detail:

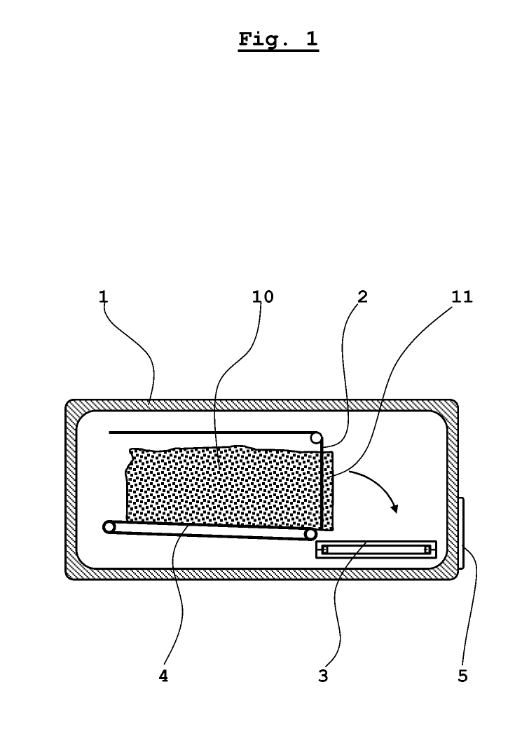

FIG. 1: is a sketch of a first embodiment of a device according to the invention in a partial sectional front view.

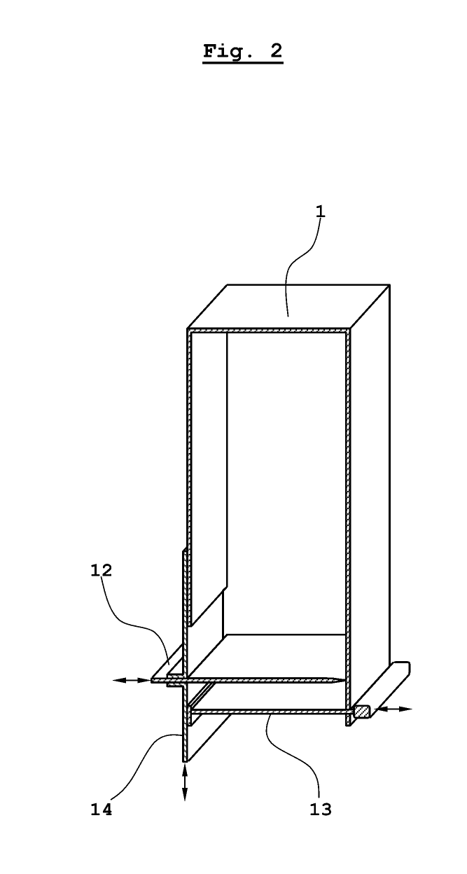

FIG. 2: is a sketch of a second embodiment of a device according to the invention in an oblique sectional view.

The sketched devices according to the invention show a device cover 1, which encloses a space that can be heated and contains the food piece 10, which is typically a “brick-like” piece of meatloaf. (Other names for “meatloaf” are “baked sausage loaf” and “Bavarian meat loaf.”)

The heat source and/or sources are not shown. All baking ovens and similar heating methods that can be used are considered.

According to FIG. 1, the food piece 10 is arranged on a sloping conveyor belt 4 on which it is transported to a cutting blade in a stationary, vertically oriented movable guide 2 so that the blade can cut off a slice 11. After cutting, the slice 11 falls onto an extendable plate 3. This plate carries the slice 11 out of the heated space through the door on the sectional view in FIG. 1, which is located at the front of the device cover (not shown). The operator can remove the slice with a fork and place it onto a roll or plate as required without touching the slice or the large piece from which the slice has been cut. Because the bread roll slice can be held using tongs, without being touched, the operator does not need to wear gloves for food handling.

A control panel 5 is arranged on one side of the device cover, which the operator can use to enter the size and number of portion(s) to be dispensed into the device controller. To keep operating procedures simple, the control panel can be equipped with a “Regular portion”, “Small portion” and “Large portion” button or surface as well as “Portion thickness” (in mm) and “Number of portions”.

In the design pursuant to FIG. 2, an opening is arranged in the device cover 1 on the bottom. This can be closed by a horizontally movable slide 13, on which the bottom of the food piece rests when closed. The cutting blade 12 is movable in a horizontal guide 14 in a way that it can pass through the bottom of the space that is enclosed by the device cover 1 in a horizontal plane. The guide 14 itself is moveable in relation to the device cover 1.

In a typical work cycle, the extended cutting blade 12 is pushed to the correct height by vertical displacement of the guide 14, then moved into the space that is enclosed by the device cover 1, so that it cuts off the lower piece of the food piece and the remaining food piece comes to rest on the top of the cutting blade 12. The slide 13 is then moved into the open position. This stops the piece of food that has been cut off and is located on the slide at a stopping area, allowing the slide to glide away under it. The food piece that has been cut off drops downwards. A plate or a roll half onto which the food piece falls can be kept under the device without needing to be touched again, in line with requirements. On the device, the slide 13 is closed again and the cutting blade 12 is extended again, so that the remaining piece of food can slide downwards again.

Because the cut surface of the remaining piece lies against the cutting blade while nothing is being taken from it, rather than being left open as in other ovens, no unwanted parched or burnt layer will form on it.

The food piece can be put into the device initially through a separate door, which is arranged either on one side or on the top of the device.

The device can be combined with other elements, such as a device for bringing up plates below the slider 13, or a device for cutting and bringing up bread roll halves.

In addition to the advantage of time being saved as there is no requirement to put on or take off gloves, the device according to the invention also saves energy, since the heated space is always opened only briefly and a small dispensing opening is also sufficient.

Beyond the construction methods and functions discussed in the context of the invention, many other designs and many additional advantageous functions and variants are, of course, also possible. For example, the heater is suitable not only for keeping the food piece hot, but also for heating. Furthermore, the controller can also include many beneficial program functions, such as size type setting, programmability during heating, etc. The device could also include a cooling function, so that for example a food piece could be put in during the evening and kept cool until the next morning, heated up after a specific time and kept hot until a later set time.

1. Device for the provision of hot or warm food portions as a section of a larger piece of food that is being kept hot or warm, for which the device is equipped with a heated space in which the larger piece of food is kept hot or warm, characterised in that
the device comprises a cutting device containing a mechanical drive, which is capable of cutting off a portion from a food piece,
the device comprises a moving device containing a mechanical drive, which is capable of pushing the cutting device and the food piece towards each other,
the device has a dispensing device through which the portion that has been cut off the food piece can be dispensed from the heated area, and
the device has a controller into which the size or weight of the piece of food to be cut off and dispensed can be entered and which is capable of controlling the moving device and the cutting device.

2. Device according to claim 1, characterised in that the dispensing device can be mechanically driven and controlled by the controller.

3. Device according to claim 1, characterised in that the opening through which the portion that has been cut off the food piece can be dispensed is opened and closed by a mechanically driven closure, which is controlled by the controller.

4. Device according to claim 1, characterised in that an opening is arranged from the heated space and the bottom of it and that it is opened and closed by a slide arranged there, and that the top lies against the food piece when it is closed and that a cutting blade above the slide can be inserted into the food piece.

5. A device according to claim 1, characterised in that the food piece is meatloaf.
